(19) United States
(12) Patent Application Publication
(10) Pub. No.: US 2020/0136905 A1
(43) Pub. Date: Apr. 30, 2020

(54) CONFIGURATION ENTITY RATING

(71) Applicant: Hewlett Packard Enterprise Development LP, Houston, TX (US)

(72) Inventors: Nrupenbhai Dilipbhai Chudasma, Bangalore (IN); Parshadkumar Shardulkumar Patel, Bangalore (IN); Vinay Sreekumar Pathiyarathodi, Bangalore (IN); Vinayaka Naik Vasantha, Bangalore (IN); Vivek Balasubramanian, Bangalore (IN); Harsh Patel, Bangalore (IN)

(21) Appl. No.: 16/174,637

(22) Filed: Oct. 30, 2018

(51) Int. Cl. H04L 12/24

(52) U.S. Cl. CPC H04L 41/0823; H04L 41/0893; H04L 41/0843

(57) ABSTRACT

A method may include identifying a plurality of constraints corresponding to a plurality of configuration entities comprising at least a first configuration entity and a second configuration entity. The plurality of constraints can match particular configuration values for the plurality of configuration entities. The method may further include assigning rating values to constraints that match the particular configuration values. The rating values can be based on an importance criterion corresponding to the first configuration entity and the second configuration entity respectively. The method can further include generating a configuration scoring and ranking template comprising information corresponding to the plurality of constraints and the particular configuration values and assigning the first configuration entity to a first network category and the second configuration entity to a second and different network category. The first and second network categories can have different rating values assigned to the constraints that match the particular configuration values.

### BACKGROUND

Networks can include multiple network devices and/or network groups that are in communication with one another. Such network devices and/or groups can be configured to facilitate communication in order for the network to function. Network devices and/or network groups can include default configurations to allow them to be used in a network.

### BRIEF DESCRIPTION OF THE DRAWINGS

FIG. 1A illustrates a block diagram in the form of an example apparatus including a configuration component consistent with the disclosure.

FIG. 1B illustrates another block diagram in the form of an example apparatus including a configuration component consistent with the disclosure.

FIG. 1C illustrates a block diagram in the form of an example apparatus including a configuration component and configuration scoring and ranking template consistent with the disclosure.

FIG. 1D illustrates another block diagram in the form of an example apparatus including a configuration component and configuration scoring and ranking template consistent with the disclosure.

FIG. 2 illustrates an example flow for configuration entity rating consistent with the disclosure.

FIG. 3 illustrates an example flow diagram for configuration entity ranking consistent with the disclosure.

FIG. 4 illustrates an example machine-readable medium for configuration entity ranking consistent with the disclosure.

### DETAILED DESCRIPTION

When a network is set up, it may be desirable to understand how the various network devices and/or network groups that are part of the network are configured. Some network devices and/or network groups include default configurations that can allow for a participation in a network with minimal initial configuration, however, the default configurations may not provide the security, capability, and/or features that may be demanded of the network in which the network devices and/or groups are deployed.

In order to provide increased network functionality through improved network configurations, network devices and/or network groups can be configurable. However, altering the default configurations of the network devices and/or network groups can result in decreased performance as a result of incompetence or human error during the configuration stage. In addition, alteration of default network configurations can be a time-consuming and/or labor-intensive endeavor.

For example, in some approaches, a network administrator may manually determine configuration failures (e.g., loop-holes) of a network. Such failures or loop-holes can include configurations that are bad or undesirable for the network. After identifying the configuration loop-holes (e.g., undesirable configurations for the network), the network administrator may define configuration criteria that configuration entities (e.g., devices, groups, etc.) of the network should match. As used herein, “configuration entities” refer, for example, to network devices, groups of network devices, etc. that work in concert to form a computing network, such as a wireless local area network (WLAN). Non-limiting examples of configuration entities include routers, access points, switches, and/or hubs, among other network components.

Once the network administrator has defined configuration criteria for the configuration entities, in some approaches the network administrator may then check the configuration entities to determine how many devices and/or groups such criteria match or do not match. For example, the network administrator may check each configuration entity to determine if configuration criteria corresponding to the network match each configuration entity. Using this information, the network administrator may then attempt to fix bad or undesirable configurations in the network.

As used herein, “configuration criteria” can refer to, for example, ideal or pseudo-ideal configuration parameters for a network. For example, configuration criteria can include media access control addresses for the network, port allocation for the network, intrusion detection and prevention protocols for the network, security level settings for the network, authentication server information for the network, etc. A desirable network configuration can be a configuration in which the configuration criteria match the behavior of the configuration entities.

The above approaches can rely on the network administrator manually identifying configuration parameters of the network, determining configuration criteria, and/or matching the configuration criteria to the configuration entities to determine what course of action to take regarding the configuration entities. For example, the network administrator may, in some approaches, perform the above listed operations to determine which, if any, configuration entities should be modified to improve the network configuration.

This can involve substantial time and effort on the part of the network administrator, who may perform the above operations multiple times in order to achieve an optimized network configuration. This can be further exacerbated as new configuration entities are added to the network and/or when one or more configuration parameters for the network are modified. As a result, approaches described above may incur substantial time and effort on the part of the network administrator and/or may not be scalable as the number of configuration entities in the network increase.

In contrast, examples described herein can allow fora quality of a network configuration to be determined and/or improved. For example, some examples herein are directed to matching configuration entities to configuration criteria, generating a rating(s) for the configuration criteria, and/or determining a weighted score for the configuration criteria. This can allow for network configurations to be improved without the substantial time and effort characterized by some approaches.

In some examples, a configuration scoring and ranking template (CSR template) can be generated to further assist in matching, rating, and generating weighted scores for the configuration criteria. The CSR template can be a framework that can be used to define the configuration criteria and can be used for evaluating various configuration entities in the network to determine how changes to the network configuration may affect the overall network configuration. This may be useful in analyzing theoretical network configurations to determine how changes to the network configuration can alter the network configuration, determining an optimized network configuration, re-configuring the network in response to new configuration entities joining (or old configuration entities leaving) the network, and/or comparing the behavior of the network configuration to other network configurations that include similar configuration entities.

Examples of the disclosure include apparatuses, methods, and systems for related to configuration component rating. In some examples, a method may include identifying a plurality of constraints corresponding to a plurality of configuration entities comprising at least a first configuration entity and a second configuration entity. The plurality of constraints can match particular configuration values for the plurality of configuration entities. The method may further include assigning rating values to constraints that match the particular configuration values. The rating values can be based on an importance criterion corresponding to the first configuration entity and the second configuration entity respectively. The method can further include generating a configuration scoring and ranking template comprising information corresponding to the plurality of constraints and the particular configuration values and assigning the first configuration entity to a first network category and the second configuration entity to a second and different network category. The first and second network categories can have different rating values assigned to the constraints that match the particular configuration values.

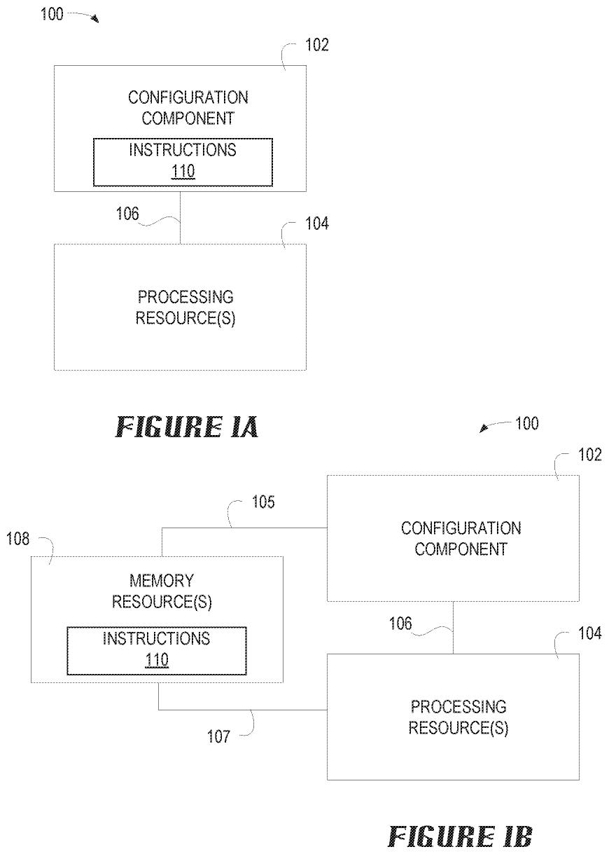

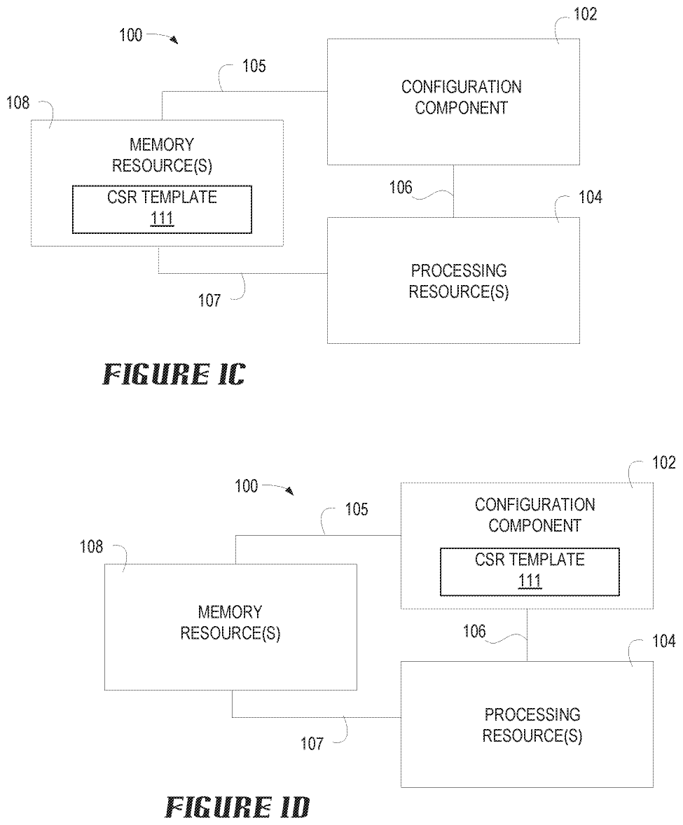

FIG. 1A illustrates a block diagram in the form of an example apparatus 100 including a configuration component 102 consistent with the disclosure. In FIG. 1A, the apparatus 100 includes a configuration component 102, and a processing resource(s) 104. The configuration component 102 can be in communication with the processing resource(s) 104 via a communication link 106. In some examples, the configuration component 102, processing resource(s) 104, and/or the instructions 110 may be separately considered an “apparatus.”

The communication link 106 can be a physical communication link, such an interface, wire, or other physical communication path to provide communication between the configuration component 102 and the processing resource(s) 104. Examples are not so limited, however, and the communication link 106 can be a wireless communication link 106 such as a wireless connection or other wireless communication link to provide communication between the configuration component 102 and the processing resource(s) 104 in a wireless manner. For example, the communication link 106 can be a communication link in compliance with a wireless local area network (WLAN) standard, long term evolution (LTE) standard, BLUETOOTH® (or BLUETOOTH® Low Energy standard), etc.

The processing resource(s) 104 can include hardware, circuitry, and/or logic that can be configured to execute instructions (e.g., computer code, software, machine code, etc.) to perform tasks and/or functions to facilitate configuration entity ranking as described in more detail herein.

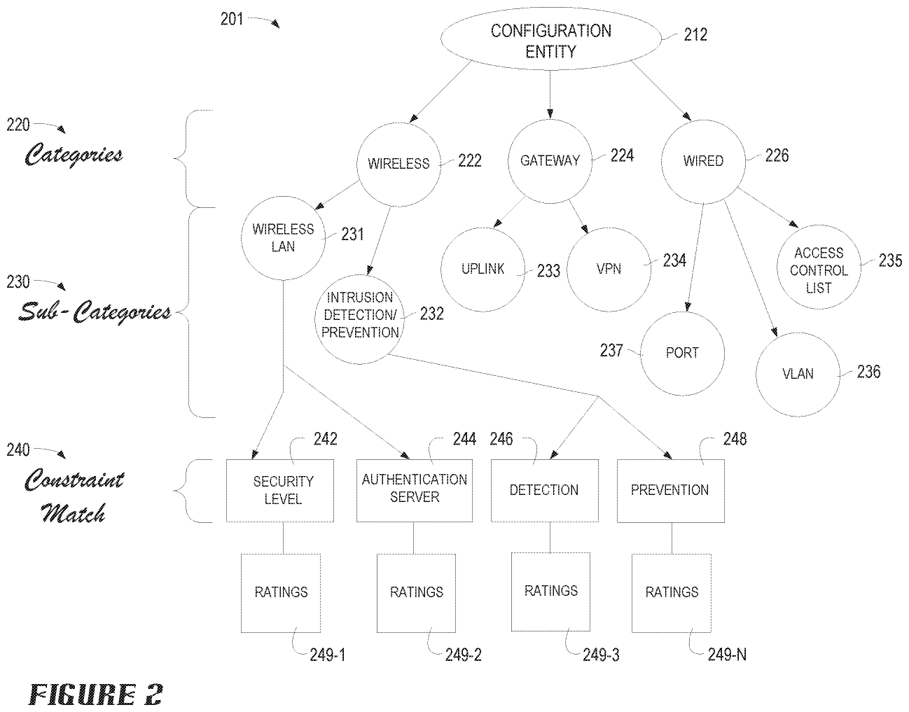

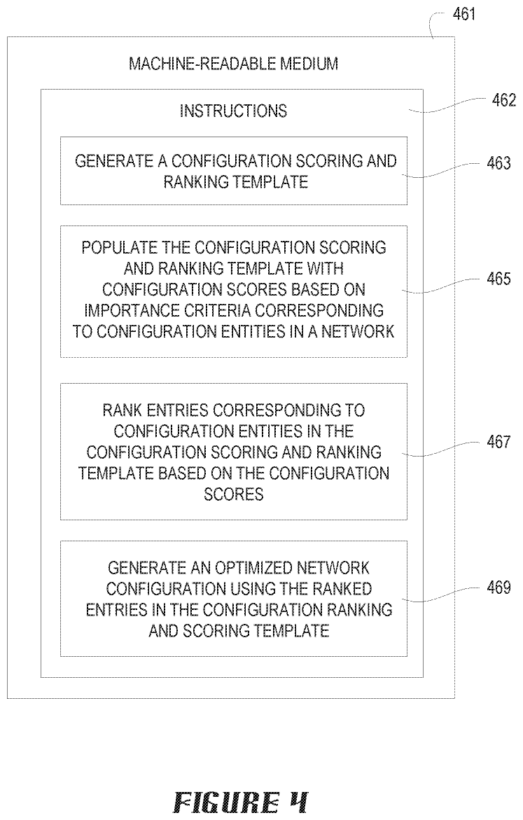

The configuration component 102 can include hardware, circuitry, and/or logic that can be configured to execute instructions (e.g., computer code, software, machine code, etc.) to perform tasks and/or functions to facilitate configuration entity ranking as described in more detail herein. In some examples, the configuration component 102 can be deployed (e.g., physically disposed on) a configuration entity such as configuration entity 212 illustrated in FIG. 2, herein. Examples are not so limited, however, and in some examples the configuration component 102 can be communicatively coupled to a configuration entity in order to facilitate configuration entity ranking. As shown in FIG. 1A, the configuration component 102 can include instructions 110, which can be analogous to instructions 462 described in more detail in connection with FIG. 4, herein.

For example, the configuration component 102 can cause a plurality of constraints corresponding to a plurality of configuration entities (e.g., configuration entity 212 illustrated in FIG. 2) to be determined. As discussed above, the configuration entities can include network devices (e.g., routers, switches, hubs, access points, etc.) and/or network groups (e.g., groups of computing systems and/or computing hardware devices that are linked together through communication channels to facilitate communication and/or resource-sharing).

As used herein, “constraints” refer to ranges of parameters corresponding to configuration entities that facilitate network functionality. For example, a constraint can refer to a particular range corresponding to a parameter associated with a configuration entity within which the network functions or is optimized. Non-limiting examples of constraints can include ranges corresponding to configuration values such as security values, message authentication code (MAC) authentication values, certificate usage values, etc. For example, a constraint can be whether a security value for a WLAN is open, personal, or enterprise. Similarly, a constraint corresponding to MAC authentication values can be whether MAC authentication is enabled or disabled.

In some examples, the configuration component 102 can cause a determination to be made that a constraint matches a configuration value associated with the plurality of configuration entities. As used herein, a “configuration value” refers to a configurable value corresponding to configuration entities. Non-limiting examples of configuration values can include security levels (e.g., security level 242 illustrated in FIG. 2, herein), authentication servers (e.g., authentication server 244 illustrated in FIG. 2, herein), intrusion detection (e.g., detection 246 illustrated in FIG. 2, herein) parameters, intrusion prevention (e.g., prevention 248 illustrated in FIG. 2, herein) parameters, etc. Configuration values are described in more detail in connection with FIG. 2, herein.

The configuration component 102 can cause rating values to be assigned to the configuration values. For example, the configuration component 102 can cause values that correspond to scaled rating values that can be assigned to security levels, authentication servers, intrusion detection parameters, intrusion prevention parameters, etc. for the configuration entities. The rating values can be numerical, such as 0-5, 0-10, 0-100, etc.; however, examples are not limited strictly to numerical rating values.

The rating values can be based, at least in part, on the determination that the constraint matches the configuration values. For example, if a configuration value does not match the constraint, a rating value of “0” can be assigned to the corresponding constraint or configuration value. In contrast, if a configuration value does match the constraint, a non-zero (e.g., 5, 10, 100, etc.).

In some examples, the rating values can be based on an importance criterion corresponding to respective configuration entities of the plurality of configuration entities. As used herein, an “importance criterion” refers to a level of importance of a particular configuration entity or configuration value. For example, it may be useful in a particular network to assign a higher priority to intrusion prevention than to a security level of the network. In such an example, intrusion could be a higher importance criterion than the security level of the network.

In some examples, the configuration component 102 can cause configuration scores to be generated for the configuration entities. The configuration scores can be based on the rating values. For example, the configuration scores can be based on rating values corresponding to the configuration rating and scoring (CSR) template described in more detail in connection with FIGS. 10 and 1D, herein. As described in more detail in connection with FIG. 2, the configuration scores can correspond to configuration scores for categories (e.g., the categories 220 illustrated in FIG. 2, herein), sub-categories (e.g., the sub-categories 230 illustrated in FIG. 2, herein), or combinations thereof.

For example, the configuration component 102 can cause a determination to be made that constraint matches the configuration value associated with the plurality of configuration entities based, at least in part, on application of the configuration scoring and ranking template. Accordingly, the CSR template can include information corresponding to the constraints and/or configuration values as described in more detail in connection with FIGS. 1C and 1D, herein.

In some examples, the configuration scores can include weighted averages of the rating values assigned to the configuration values. For example, the configuration scores can include weighted averages of the rating values such that all configuration score for a particular configuration value yield a total 100% weight. In some examples, the weighted averages for the rating values can yield a total 100% weight for all categories (e.g., categories 220 illustrated in FIG. 2, herein), sub-categories (e.g., sub-categories 230 illustrated in FIG. 2, herein), and/or constraint matches (e.g., constraint match 240 illustrated in FIG. 2, herein).

The configuration component 102 can further cause generation of an optimized network configuration based on the configuration scores. For example, the configuration component 102 can rank the configuration scores based on a quality of network performance, security level for the network, etc. In some examples, the configuration component 102 can rank the configuration scores based on a quality of network performance associated with respective configuration entities in the network.

FIG. 1B illustrates another block diagram in the form of an example apparatus 100 including a configuration component 102 consistent with the disclosure. In FIG. 1B, the apparatus 100 includes a configuration component 102, processing resource(s) 104, and memory resource(s) 108. The configuration component 102 can be in communication with the processing resource(s) 104 via a communication link 106.

The memory resource(s) 108 can include instructions 110, which can be analogous to the instructions 462 illustrated in FIG. 4, herein. The memory resource(s) 108 can be in communication with the configuration component 102 via a communication link 105, and the memory resource(s) 108 can be in communication with the processing resource(s) 104 via communication link 107. In some examples, the configuration component 102, processing resource(s) 104, memory resource(s) 108, and/or the instructions 110 may be separately considered an “apparatus.”

The memory resource(s) 108 can include volatile (e.g., dynamic random-access memory, static random-access memory, etc.) memory and/or non-volatile (e.g., one-time programmable memory, hard disk(s), solid state drive(s), optical discs, etc.).

In some example, the processing resource(s) 104 can execute the instructions 110 stored by the memory resource(s) 108 to cause the configuration component 102 to perform configuration entity rating, as supported by the disclosure.

FIG. 1C illustrates a block diagram in the form of an example apparatus 100 including a configuration component 102 and configuration scoring and ranking (CSR) template 111 consistent with the disclosure. In FIG. 1C, the apparatus 100 includes a configuration component 102, processing resource(s) 104, and memory resource(s) 108, which can include a CSR template 111. The configuration component 102 can be in communication with the processing resource(s) 104 via a communication link 106.

The memory resource(s) 108 can be in communication with the configuration component 102 via a communication link 105, and the memory resource(s) 108 can be in communication with the processing resource(s) 104 via communication link 107. In some examples, the configuration component 102, processing resource(s) 104, memory resource(s) 108, and/or the instructions 110 may be separately considered an “apparatus.”

The CSR template 111 can serve as a framework for matching constraints to configuration values, organizing rating values for the configuration values, and/or organizing weightages determined for the rating values. Such parameters can be evaluated using the CSR template 111 for configuration entities (e.g., the configuration entity 212 illustrated in FIG. 2, herein) of a network. In some examples, use of the CSR template 212 can facilitate rankings of the configuration entities (and values corresponding thereto) to improve or optimize a network configuration.

An example of pseudo-code for generation (e.g., for defining) the CSR template follows. Although the pseudo-code example herein is formatted in the JavaScript Object Notation (JSON), examples are not so limited, and other formats such as YAML Aint' Markup Language (YAML), Unified Modeling Language (UML), etc. are contemplated by the disclosure.

```
CSRT = {
      “Categories”: {
            “C1”: {
                  “Criteria”: {
                          “C1R1”: {
                                “Match”: “C1R2Match”,
                                “Rating”: “0-10”,
                                “Weightage”: “0-100”,
                          },
                          “C1R2”: {
                                “Match”: “C1R2Match”,
                                “Rating”: “0-10”,
                                “Weightage”: “0-100”,
                          }
                  },
                  “Weightage”: “0-100”
            },
            “C2”: {
                  “Criteria”: {
                          “C2R1”: {
                                “Match”: “C2R1Match”,
                                “Rating”: “0-10”,
                                “Weightage”: “0-100”,
                          },
                          “C2R2”: {
                                “Match”: “C2R2Match”,
                                “Rating”: “0-10”,
                                “Weightage”: “0-100”,
                          },
                          “C2R3”: {
                                “Match”: “C2R3Match”,
                                “Rating”: “0-10”,
                                “Weightage”: “0-100”,
                          }
                  },
                  “Weightage”: “0-100”
            },
            . . .
            “Cn”: {
                  “Criteria”: {
                          “CnR1”: {
                                “Match”: “CNR1Match”,
                                “Rating”: “0-10”,
                                “Weightage”: “0-100”,
                          },
                          “CnR2”: {
                                “Match”: “CNR2Match”,
                                “Rating”: “0-10”,
                                “Weightage”: “0-100”,
                          },
                          . . .
                          “CnRm”: {
                                “Match”: “CNRMMatch”,
                                “Rating”: “0-10”,
                                “Weightage”: “0-100”,
                          },
                  },
                  “Weightage”: “0-100”
            }
      }
}
```

In the above pseudo-code example, constraints (e.g., criteria) for each category (e.g., categories 220 illustrated in FIG. 2, herein) are defined. The criteria are iteratively defined for each category in the above pseudo-code example. For example, criteria corresponding to a first category (“C1”), a second category (“C2”), through an n^{th} category (“Cn”) are defined. For each of the criteria, a determination as to whether the criteria matches a configuration value is made. In addition, a rating value is assigned to each criterion for each category, and a weightage is assigned to each criterion for each category. In the example pseudo-code above, the rating value for each criterion is defined to be between 0 and 10, while the weightage is defined to be between 0 and 100. As noted above, these are merely examples, and other ranges for the rating values and/or weightages can be ascribed to each criterion.

For each category, a weightage of all the criteria corresponding to that particular category is further defined. In the above pseudo-code example, this weightage is defined to be between 0 and 100, corresponding to the weightage for each set of criteria for each category yielding a total weight of 100%.

Although specific reference is made to categories in the above pseudo-code example, examples are not so limited. For example, the pseudo-code could include sub-categories (e.g., the sub-categories 230 illustrated in FIG. 2, herein), and/or constraint matches (e.g., the constrain match 240 illustrated in FIG. 2, herein).

FIG. 1D illustrates another block diagram in the form of an example apparatus 100 including a configuration component 102 and configuration scoring and ranking template 111 consistent with the disclosure. In FIG. 1D, the apparatus 100 includes a configuration component 102, which can include a CSR template 111, processing resource(s) 104, and memory resource(s) 108. The configuration component 102 can be in communication with the processing resource(s) 104 via a communication link 106.

The memory resource(s) 108 can be in communication with the configuration component 102 via a communication link 105, and the memory resource(s) 108 can be in communication with the processing resource(s) 104 via communication link 107. In some examples, the configuration component 102, processing resource(s) 104, memory resource(s) 108, and/or the instructions 110 may be separately considered an “apparatus.”

As shown in FIG. 1D, the configuration component 102 stores or cause the CSR template 111 to be generated. Although not explicitly shown in FIG. 1D, the memory resource(s) 108 can include instructions as shown in FIG. 1B that may be executed by the processing resource(s) 104 to cause the configuration component to perform the operations described in more detail in connection with FIG. 1A, herein. For example, the memory resource(s) 108 may store instructions that can be executed by the processing resource(s) 104 to cause the configuration component 102 to generate the CSR template 111 as described above.

In some examples, the configuration component 102 can use the CSR template 111 to determine rating values and/or weightages in accordance with the following pseudo-code example. In the following pseudo-code example, “CE” refers to a configuration entity (e.g., configuration entity 212 illustrated in FIG. 2, herein), and “CSRT” refers to the CSR template 111.

```
score, result GetScore (CE, CSRT) :
    score = 0
    # Initialize result JSON for categories/criteria score
    result = {“Categories”: { }}
    # Initialize n Category Score to 0
    CS = [0, 0, . . ., 0]
    for each category Ci in CSRT[“Categories”]:
        # set m Criteria Score to 0 under Ci category
        CRS = [0, 0, . . ., 0]
        for each criteria CiRj in CSRT [“Categories”] [Ci] [“Criteria”]:
            # ApplyMatch would apply given criteria match to
            #Configuration entity CE
            # and return the related criteria match score
            CSR[j] = ApplyMatch (CiRj[“Match”], CE)
            #Store Criteria score in result
            Result [“categories”] [Ci] [“Criteria”] [“score”] = CSR[j]
            #Form criteria rating, update the category score
            CS[i] += CSR[i] * CiRj {“Weightage”]
        #CRS is updated with each Criteria Score evaluated against
        #Configuration Object
        #CS[i] is updated with Weighted Criteria score for a given
        #Category
        result [“Categories” [Ci] [“Score”] = CS[i]
        #Update overall score with Category score against Weight
        #assigned to Category
        score += CS[i] * Ci[“Weightage”]
    #Vector CS is calculated which gives score generated in each category
    #Vector CSR under each category is calculated which constrains score
    #evaluated for each criteria
criteria
    return score, result
```

In the above pseudo-code example, the categories can correspond to the categories 220, sub-categories 230, and/or constraint matches 240 illustrated in FIG. 2, herein. The criteria can be analogous to the constraints and/or configuration values described above in connection with FIGS. 1A-1C.

After category scores are initialized, score ranges can be assigned to constraints and/or configuration values (e.g., criteria) for each category. A determination can be made as to whether constraints match configuration values for each category. The category scores (e.g., the rating values described above) can be updated as the pseudo-code is iterated. Once the category scores are updated and stored, they can be weighted and/or returned as part of configuration entity rating consistent with the disclosure.

In the above pseudo-code example, GetScore( ) can be invoked for various configuration entities to generate and/or assign score ranges to constraints and/or configuration values (e.g., criteria) for each category. A plurality of configuration entities can be ranked based on the returned score from GetScore( ) in ascending or descending order. In some examples, a configuration score and ranking can be generated for each configuration entity, which allow for a determination as to how particular configuration entities are performing in the network. This can allow for investigation in to which configuration entities are poorly configured and/or which configurations can be changed to optimize performance of the network.

In some examples, a particular CSR template 111 can be run across various devices and/or networks to generate an average and/or standard deviation for scores and rankings generated through application of the CSR template 111. This can allow for statistical analysis to be performed on networks and/or can be used to compare configurations and/or configuration entities to one another.

The CSR template 111 can be custom created and/or shown to a user or admin of the network. In some examples, the CSR template 111 can include predefined values that can be used for the network or updated over time to customize the configuration of the network.

FIG. 2 illustrates an example flow 201 for configuration entity rating consistent with the disclosure. FIG. 2 illustrates a configuration entity 212 having categories 220, sub-categories 230, and constraint matches 240 corresponding thereto.

In some examples, configurations can be divided into multiple categories 220 and/or sub-categories 230 to reduce complexity of scoring and/or ranking attributes of the configuration entity 212. The arrows connecting each of the circles in the categories 220, the sub-categories 230, and/or the constraint match 240 can represent weighted scores for each of the categories 220, sub-categories 230, and/or constraint match 240, and may yield a total weight of 100%. The weighted scores can be generated by a configuration component such as the configuration component 102 illustrated in FIGS. 1A-1D, herein. The weights can be user defined or can be generated to accommodate desired configuration ratings, as described in further detail, herein.

For example, the arrow between the configuration entity and the wireless 222 category can be assigned a weight of 60, corresponding to 60% of the total weight of the categories 220, while the arrow connecting the configuration entity 212 to the gateway 224 and the arrow connecting the configuration entity 212 to the wired 226 category can each have a weight of 20, corresponding to 20% each of the total weight for the categories 220.

As shown in FIG. 2, the categories 220 can include wireless 222, gateway 224, and/or wired 226. The wireless 222 category can correspond to devices that are connected to a network wirelessly (e.g., WLAN connected devices), the gateway 224 category can correspond to devices that are connected to a network through a gateway (e.g., a router, server, etc.), and the wired 226 category can correspond to devices that include wired connection (e.g., a switch, etc.) to the network.

As shown in FIG. 2, each category 220 can be further defined to have multiple sub-categories 230 corresponding thereto. For example, the wireless 222 category can have a sub-category 230 corresponding thereto that include internet access provider characteristics such as wireless LAN 231 protocols, intrusion detection and prevention 232 protocols, certificate usage protocols, radio frequency protocols, service protocols, etc.

As shown in FIG. 2, the gateway 224 category can have a sub-category 230 corresponding thereto that includes uplink 233 protocols, virtual private network (VPN) 234 configurations, virtual local area network (VLAN) 236 configurations, port 237 configurations, etc. In some examples, the wired 226 category can have a sub-category 230 corresponding thereto that includes port 237 protocols, VLAN 236 protocols, access control list 235 configurations, system protocols, dynamic host configuration protocols (DHCPs), message authentication code (MAC) authentication protocols, terminal access controller access control systems (TACACS) authentication and accounting protocols, remote authentication dial-in user service (RADIUS) protocols, etc.

As part of configuration entity rating, constraints (e.g., criteria) and/or configuration values can be defined for each of the categories 220 and/or the sub-categories 230. In some examples, the constraints can be defined by three factors. For example, the constraints can be defined by a match (e.g., a degree of match to a configuration value), a rating (e.g., a relative level of importance assigned to the configuration value), and/or a weight (e.g., a relative preferred state of optimization of the network configuration). Examples are not so limited, and different numbers and/or types of factors may be used to influence the values of the constraints.

The match can correspond to a simple match. For example, the match can be a condition that is satisfied by a configuration value set by a configuration entity. An example of a configuration value set by a configuration entity can be whether a security level 242 for the WLAN 231 is open, personal, or enterprise. Another example of a configuration value set by a configuration entity can be whether MAC authentication is enabled or disabled for WLAN. Other non-limiting examples of configuration values et by configuration entities can include whether a primary authentication server 242 selected is internal or is a RADIUS type server, whether certificate usage is configured for authentication server 242 interaction, or whether a given certificate is selected as a certification authority certificate.

In some examples, the match argument can consist of a simple match coupled with conditional AND/OR operators as well as any other logical operands (e.g., NOT, XOR, etc.). For example, WLAN is not a guest network and security level 242 is selected to not open. In still other examples, the match argument can be more complex. For example, a complex match argument could consist of if-elif-else conditional blocks in which a match over a particular conditional block could yield a score specified by a rating 249-1, . . . , 249-N corresponding to the particular conditional block.

Non-limiting examples of a constraint match 240 shown in FIG. 2 and include a security level 242, an authentication server 244, detection 246, and prevention 248. The security level 242 can include constraints such as whether the security level 242 is “open,” “personal,” or “enterprise” depending on the security level 242 of the network. The authentication server 244 can include constraints such as “enabled” or “disabled” depending on whether an authentication server 244 is enabled or disabled for the network. The detection 246 can include constraints such as “off,” “low,” “medium,” or “high” depending on intrusion detection schemes utilized by the network. The prevention 248 can include constraints such as “off,” “low,” “medium,” or “high” depending on intrusion prevention schemes utilized by the network.

As described above, the ratings 249-1, . . . , 249-N can include numerical values defined by the CSR template. For example, the ratings 249-1, . . . , 249-N can be 0-5, 0-10, 0-100. However, examples are not limited to numerical values and the ratings can be other types of values such as colors, pass/fail flags, etc.

In some examples, weightages can be assigned to the constraints, configuration values, and/or ratings 249-1, . . . , 249-N. The weightages can be assigned to each category 220 and/or sub-category 230 and may be used to select constraints that are preferred as part of optimizing the network configuration. In some examples, a baseline-score can be assigned to configuration entities 212 to determine whether the configuration entity 212 has a rating 249-1, . . . , 249-N that surpasses a threshold score value. For example a pass/fail flag can be assigned to configuration entities 212 based on whether the configuration entity 212 meets or exceeds a minimum level of performance as deployed in the network.

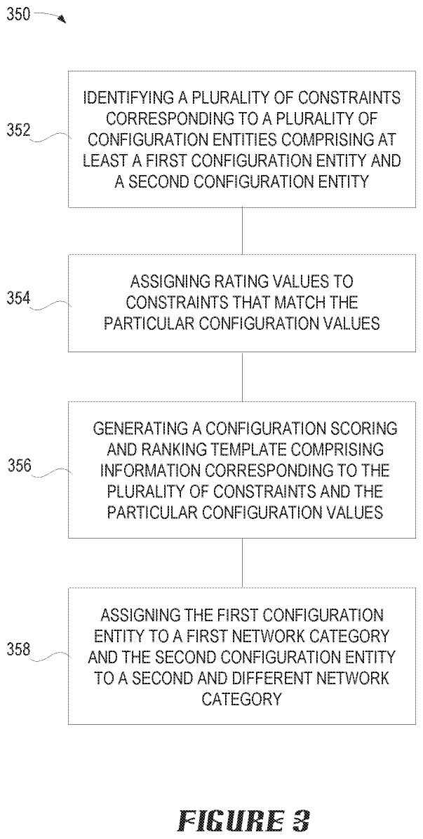

FIG. 3 illustrates an example flow diagram 350 for configuration entity rating consistent with the disclosure. At block 352, a method for configuration entity rating can include identifying a plurality of constraints corresponding to a plurality of configuration entities comprising at least a first configuration entity and a second configuration entity. The plurality of constraints can match particular configuration values for the plurality of configuration entities.

At block 354, the method can further include assigning rating values to constraints that match the particular configuration values. The rating values can be based, at least in part, on an importance criterion corresponding to the first configuration entity and the second configuration entity respectively.

At block 356, the method can further include generating a configuration scoring and ranking template comprising information corresponding to the plurality of constraints and the particular configuration values.

At block 358, the method can further include assigning the first configuration entity to a first network class and the second configuration entity to a second and different network class. The first and second network classes can have different rating values assigned to the constraints that match the particular configuration values. The first network class and/or the second class category can be either network categories, network sub-categories, or combinations thereof. For example, the first network class can be a network category such as the categories 220 illustrated in FIG. 2, herein, while the second network class can be a network sub-category such as the network sub-categories 230 illustrated in FIG. 2, herein. Examples are not so limited, however, and the first network class can be a network sub-category and the second network class can be a network category.

In some examples, the method can further include generating an optimized network configuration based, at least in part, on the weighted scores for the configuration values and/or generating weighted scores for the configuration values, based at least in part, on the rating values for particular configuration values. For example, the method can include configuring a network comprising the configuration entities to achieve a threshold network security level based, at least in part, on the weighted scores for the configuration values.

The method can further include generating different weighted scores based on different rating values for particular configuration values and/or comparing the different weighted scores to the weighted scores to determine an optimized network configuration. In some examples, ranking the weighted scores can include ranking the weighted scores based, at least in part, on a quality of network performance associated with rating values corresponding to respective configuration entities. For example, a quality of performance (e.g., network throughput, connectivity, security, etc.) can be used to determine an order in which the configuration entities are to be ranked.

FIG. 4 illustrates an example machine-readable medium 461 for configuration entity rating consistent with the disclosure. A processing resource (e.g., processing resource(s) 104 illustrated in FIGS. 1A and 1B, herein) such as a hardware computer processor may execute instructions 462 stored on the non-transitory machine readable medium 461. The non-transitory machine readable medium 461 may be any type of volatile or non-volatile memory or storage, such as random-access memory (RAM), flash memory, read-only memory (ROM), storage volumes, a hard disk, or a combination thereof.

The example medium 461 may store instructions 463 executable by the processing resource to generate a configuration scoring and ranking template.

The example medium 461 may further store instructions 465 executable by the processing resource to populate the configuration scoring and ranking table with configuration scores based on importance criteria corresponding to configuration entities in a network.

The example medium 461 may further store instructions 467 executable by the processing resource to rank entries corresponding to configuration entities in the configuration scoring and ranking template based on the configuration scores.

The example medium 461 may further store instructions 469 executable by the processing resource to generate an optimized network configuration using the ranked entries in the configuration ranking and scoring template.

In some examples, the instructions 461 can be further executable by the processing resource to assign the configuration entities to categories or sub-categories of configuration entities based, at least in part, on a functionality associated with respective configuration entities among the configuration entities. Subsequent to being assigned to categories or sub-categories, the instructions 461 can be further executable by the processing resource to rank configuration entities assigned to the categories based on first criteria and/or rank configuration entities assigned to the sub-categories based on second criteria.

In some examples, the example medium 461 may store instructions 462 executable by the processing resource to modify the configuration scoring and ranking template in response to a determination that a new configuration entity is added to the network and/or re-generate the optimized network configuration. Examples are not so limited, however, and in some examples, the example medium 461 may store instructions 462 executable by the processing resource to compare the ranked configuration scoring and ranking template to a different ranked configuration scoring and ranking template corresponding to the configuration entities to determine an average or a standard deviation between the ranked entries in the ranked configuration scoring and ranking template and the different ranked configuration scoring and ranking template.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. As used herein, designators such as “N”, etc., particularly with respect to reference numerals in the drawings, indicate that a number of the particular feature so designated can be included. A “plurality of” is intended to refer to more than one of such things. Multiple like elements may be referenced herein by their reference numeral without a specific identifier at the end.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A method, comprising:
identifying a plurality of constraints corresponding to a plurality of configuration entities comprising at least a first configuration entity and a second configuration entity, wherein the plurality of constraints that match particular configuration values for the plurality of configuration entities;
assigning rating values to constraints that match the particular configuration values, wherein the rating values are based, at least in part, on an importance criterion corresponding to the first configuration entity and the second configuration entity respectively;
generating a configuration scoring and ranking template comprising information corresponding to the plurality of constraints and the particular configuration values; and
assigning the first configuration entity to a first network class and the second configuration entity to a second and different network class, wherein the first and second network classes have different rating values assigned to the constraints that match the particular configuration values.

2. The method of claim 1, further comprising generating an optimized network configuration based, at least in part, on the weighted scores for the configuration values.

3. The method of claim 1, further comprising generating weighted scores for the configuration values, based at least in part, on the rating values for particular configuration values.

4. The method of claim 1, wherein at least one of the first network class is a network category and the second network class is a network sub-category.

5. The method of claim 1, further comprising configuring a network comprising the configuration entities to achieve a threshold network security level based, at least in part, on the weighted scores for the configuration values.

6. The method of claim 1, further comprising:
generating different weighted scores based on different rating values for particular configuration values; and
comparing the different weighted scores to the weighted scores to determine an optimized network configuration.

7. The method of claim 6, ranking the weighted scores based, at least in part, on a quality of network performance associated with rating values corresponding to respective configuration entities.

8. An apparatus, comprising:
a configuration component provisioned with processing resources, the configuration component to cause:
a plurality of constraints corresponding to a plurality of configuration entities to be determined;
a determination to be made that a constraint matches a configuration value associated with the plurality of configuration entities;
rating values to be assigned to the configuration values, wherein the rating values are based, at least in part, on the determination that the constraint matches the configuration values and an importance criterion corresponding to respective configuration entities among the plurality of configuration entities; and
configuration scores to be generated for the plurality of configuration entities, wherein the configuration scores are based, at least in part, on the rating values.

9. The apparatus of claim 8, wherein the plurality of configuration entities comprise network devices, network groups, or combinations thereof.

10. The apparatus of claim 8, wherein the configuration component is to cause generation of a configuration scoring and ranking template, and wherein the configuration scoring and ranking template comprises information corresponding to the plurality of constraints and the configuration values.

11. The apparatus of claim 10, wherein the configuration component is to cause the determination to be made that constraint matches the configuration value associated with the plurality of configuration entities based, at least in part, on application of the configuration scoring and ranking template.

12. The apparatus of claim 8, wherein the configuration score corresponds to a configuration score for categories of the plurality of configuration entities, sub-categories of the plurality of configuration entities, or combinations thereof.

13. The apparatus of claim 8, wherein the configuration score comprises a weighted average of the rating values assigned to the configuration values.

14. The apparatus of claim 8, wherein the configuration component is to generate an optimized network configuration based, at least in part, on the configuration scores.

15. The apparatus of claim 8, wherein the configuration component is to rank the configuration scores based, at least in part, on a quality of network performance associated with respective configuration entities among the plurality of configuration entities.

16. A non-transitory machine-readable medium storing instructions executable by a processing resource to cause a computing device to:
generate a configuration scoring and ranking template;
populate the configuration scoring and ranking template with configuration scores based on importance criteria corresponding to configuration entities in a network;
rank entries corresponding to configuration entities in the configuration scoring and ranking template based on the configuration scores; and
generate an optimized network configuration using the ranked entries in the configuration ranking and scoring template.

17. The medium of claim 16, wherein the instructions are further executable by the processing resource to cause the computing device to assign the configuration entities to categories or sub-categories of configuration entities based, at least in part, on a functionality associated with respective configuration entities among the configuration entities.

18. The medium of claim 17, wherein the instructions are further executable by the processing resource to cause the computing device to:
rank configuration entities assigned to the categories based on first criteria; and
rank configuration entities assigned to the sub-categories based on second criteria.

19. The medium of claim 16, wherein the instructions are further executable by the processing resource to cause the computing device to:
modify the configuration scoring and ranking template in response to a determination that a new configuration entity is added to the network; and
re-generate the optimized network configuration.

20. The medium of claim 16, wherein the instructions are further executable by the processing resource to cause the computing device to compare the ranked configuration scoring and ranking template to a different ranked configuration scoring and ranking template corresponding to the configuration entities to determine an average or a standard deviation between the ranked entries in the ranked configuration scoring and ranking template and the different ranked configuration scoring and ranking template.
